(19) United States
(12) Patent Application Publication
(10) Pub. No.: US 2017/0058770 A1
(43) Pub. Date: Mar. 2, 2017

(54) SYSTEM AND METHOD FOR DECOUPLING STEAM PRODUCTION DEPENDENCY FROM GAS TURBINE LOAD LEVEL

(71) Applicant: General Electric Company, Schenectady, NY (US)

(72) Inventors: Daniel Doyle Vandale, Greenville, SC (US); Michael Anthony Cocca, Atlanta, GA (US); Joseph Phillip Klosinski, Atlanta, GA (US); James Harper, Greenville, SC (US)

(21) Appl. No.: 15/237,694

(22) Filed: Aug. 16, 2016

Related U.S. Application Data
(60) Provisional application No. 62/210,618, filed on Aug. 27, 2015.

(51) Int. Cl. F02C 6/18; F01N 5/02; H02K 7/18; F02C 3/13; F02C 3/34; F01N 3/10; F01K 11/02

(52) U.S. Cl. CPC F02C 6/18; F01N 3/10; F01N 5/02; F01K 11/02; F02C 3/13; F02C 3/34; H02K 7/1823

(57) ABSTRACT

A system for decoupling steam production dependency from gas turbine load includes a gas turbine having an inlet system, a compressor, a combustor and a turbine. The combustor includes a plurality of axially staged fuel injectors positioned downstream from a plurality of primary fuel nozzles and a center fuel nozzle. The gas turbine further includes at least one bleed air extraction port that is in fluid communication with at least one of the compressor, a compressor discharge casing or the combustor. The system also includes a diluent injection system that is in fluid communication with the combustor and an exhaust section that is disposed downstream from the turbine. The exhaust section includes an oxidation catalyst system and a heat recovery steam generator.

### CROSS REFERENCE TO RELATED APPLICATIONS

The present application claims filing benefit of U.S. Provisional Patent Application Ser. No. 62/210,618 having a filing date of Aug. 27, 2015, which is incorporated by reference herein in its entirety.

### FIELD OF THE INVENTION

The present invention generally relates to a gas turbine power plant such as a combined cycle or cogeneration power plant having a steam source and a Dry Low NOx (DLN) combustion system. More particularly, the present invention relates to a system and method for decoupling steam production dependency from gas turbine load level while operating the DLN combustion system in a non-premix mode.

### BACKGROUND OF THE INVENTION

A gas turbine power plant such as a combined cycle or cogeneration power plant generally includes a gas turbine having a compressor, a combustor and a turbine, a heat recovery steam generator (HRSG) that is disposed downstream from the turbine and a steam turbine in fluid communication with the HRSG. During operation, air enters the compressor via an inlet system and is progressively compressed as it is routed towards a compressor discharge or diffuser casing that at least partially surrounds the combustor. At least a portion of the compressed air is mixed with a fuel and burned within a combustion chamber defined within the combustor, thereby generating high temperature and high pressure combustion gases.

The combustion gases are routed along a hot gas path from the combustor through the turbine where they progressively expand as they flow across alternating stages of stationary vanes and rotatable turbine blades which are coupled to a rotor shaft. Kinetic energy is transferred from the combustion gases to the turbine blades thus causing the rotor shaft to rotate. The rotational energy of the rotor shaft may be converted to electrical energy via a generator. The combustion gases exit the turbine as exhaust gas and the exhaust gas enters the HRSG. Thermal energy from the exhaust gas is transferred to water flowing through one or more heat exchangers of the HRSG, thereby producing superheated steam. The superheated steam is then routed into the steam turbine which may be used to generate additional electricity, thus enhancing overall power plant efficiency.

Regulatory requirements for low emissions from gas turbine based power plants have continually grown more stringent over the years. Environmental agencies throughout the world are now requiring even lower levels of emissions of oxides of nitrogen (NOx) and other pollutants and carbon monoxide (CO) from both new and existing gas turbines. In order to balance fuel efficiency with emissions requirements, various types of gas turbines utilize a Dry Low NOx (DLN) type combustion system which utilizes lean premix combustion technology.

A DLN-1 or DLN-1+ type combustor by General Electric Co. is a two-stage pre-mixed combustor designed for use with natural gas fuel and may be capable of operation on liquid fuel. The DLN-1 or DLN-1+ type combustor provides a fuel injection system including a secondary fuel nozzle positioned on the center axis of the combustor surrounded by a plurality of primary fuel nozzles annularly arranged around the secondary fuel nozzle. At between about seventy percent of full load to about one hundred percent of full load, the DLN-1 or DLN-1+ type combustor may be configured to maintain very low exhaust emission levels while maintaining high levels of efficiency using lean premixed fuel/air concepts. However, at lower load levels (i.e. less than about seventy percent of full load or in a non-premix operating mode) the DLN-1 or DLN-1+ combustion system may operate outside of desired emissions levels.

Traditionally, due at least on part to emissions restrictions, the gas turbine load for a combined cycle or cogeneration power plant has been coupled to or driven by steam production requirements for the power plant. For example, to meet power plant steam demand while maintaining acceptable emissions levels, it has been necessary to operate the combustors in premix mode even when grid demand or power plant demand for electricity is low, thereby reducing overall power plant efficiency. Accordingly, there is a need to provide a system and method for decoupling the steam production dependency from gas turbine load level while maintaining emissions within desired levels when operating the combustor in non-premix mode.

### BRIEF DESCRIPTION OF THE INVENTION

Aspects and advantages of the invention are set forth below in the following description, or may be obvious from the description, or may be learned through practice of the invention.

One embodiment of the present invention is a system for decoupling steam production dependency from gas turbine load. The system includes a gas turbine having an inlet system, a compressor, a combustor and a turbine. The combustor comprises a plurality of axially staged fuel injectors positioned downstream from a plurality of primary fuel nozzles and a center fuel nozzle. The gas turbine further comprises at least one bleed air extraction port in fluid communication with at least one of the compressor, a compressor discharge casing or the combustor. A diluent supply is in fluid communication with the combustor and an exhaust section is disposed downstream from the turbine. The exhaust section comprises an oxidation catalyst system and a heat recovery steam generator. The oxidation catalyst system and the heat recovery steam generator receive an exhaust gas from an outlet of the turbine.

Another embodiment of the present disclosure includes a method for decoupling steam production dependency from gas turbine load. The method includes burning a fuel to generate a flow of combustions gases through a hot gas path of a combustor where the fuel is burned in at least one of a primary combustion zone and a secondary combustion zone of the combustor and where the primary combustion zone and the secondary combustion zone are formed upstream from a plurality of axially staged fuel injectors. The method further includes injecting a diluent into the flow of combustion gases within the hot gas path. The diluent is injected into the flow of combustion gases at a location that is defined downstream from the primary combustion zone and the secondary combustion zone and upstream from the plurality of axially staged fuel injectors. The method also includes exhausting the flow of combustion gases through a heat recovery steam generator.

Another embodiment of the present disclosure includes a method for decoupling steam production dependency from gas turbine load. The method includes burning a fuel to generate a flow of combustions gases through a hot gas path of a combustor where the fuel is burned in at least one of a primary combustion zone and a secondary combustion zone of the combustor and where the primary combustion zone and the secondary combustion zone are formed upstream from a plurality of axially staged fuel injectors. The method also includes injecting a diluent into at least one of the primary combustion zone via a plurality of primary fuel nozzles and into the secondary combustion zone via a center nozzle where the diluent mixes and burns with the fuel upstream from the plurality of axially staged fuel injectors. The method further includes exhausting the flow of combustion gases through a heat recovery steam generator disposed within an exhaust stack.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a functional block diagram of an exemplary gas turbine based power plant within the scope of the present disclosure;

FIG. 2 is a simplified cross sectioned side view of an exemplary Dry Low NOx combustor according to at least one embodiment of the present disclosure;

FIG. 3 provides a block diagram of a first embodiment of a method for decoupling steam production dependency from gas turbine load; and

FIG. 4 provides a block diagram of a second embodiment of a method for decoupling steam production dependency from gas turbine load.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, “gas turbine load” or “load” may relate to the power output of a gas turbine's generator(s); “inlet guide vane angle” means the angles of inlet vanes (not shown) relative to axial flow through the inlet system upstream from the compressor; “inlet bleed heat” means the amount of heat in fluid extracted from a downstream portion of the compressor section and inserted into the inlet system or an upstream portion of the compressor section to heat the flow therein; “fuel split” means the amount of fuel sent to different circuits within the combustor and “emissions” or “emissions level” means levels of various exhaust gases including but not limited to oxides of nitrogen (NOx), unburned hydrocarbons and carbon monoxide (CO).

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

An embodiment of the present invention takes the form of a system and method for decoupling steam production dependency from gas turbine load. In particular embodiments, the disclosure provides a power plant having a DLN1 type combustor, an axial fuel staging system (LLI), a combustion air bypass (over board bleed) and/or inlet bleed heating, diluent (i.e. steam, water of nitrogen) injection for NOx control in non-premix mode of the combustor, and steam production controls software for operational flexibility. A CO catalyst may also be provided to control CO emissions at low loads. The system and method as provided herein provides a power plant operator who has steam available (CC, cogen, etc.) with operational flexibility by giving them the ability to operate in emissions compliance from full speed no-load (FSNL) up to base load, and to decouple steam production from the gas turbine load level.

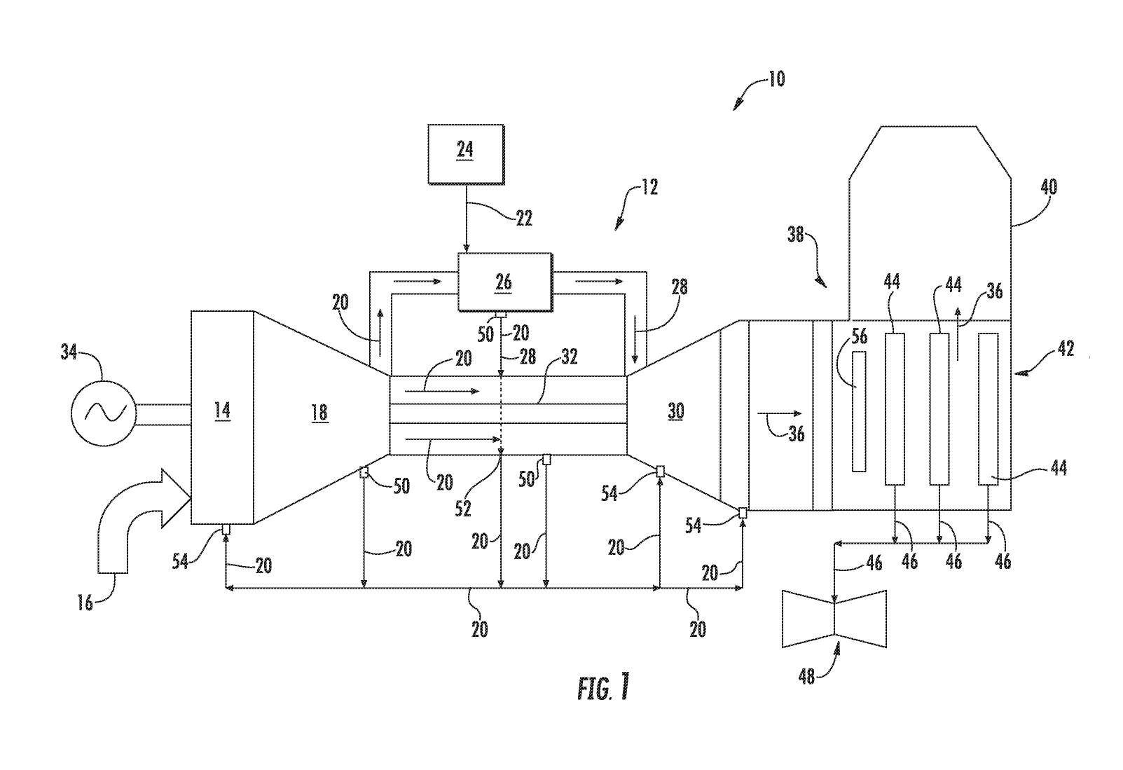

Referring now to the drawings, wherein identical numerals indicate the same elements throughout the figures, FIG. 1 provides a functional block diagram of an exemplary gas turbine power plant 10 with steam production capability. The power plant 10 comprises a gas turbine 12 that may incorporate various embodiments of the present invention. As shown, the gas turbine 12 generally includes an inlet system 14 that may include a series of filters, cooling coils, heating coils, moisture separators, and/or other devices (not shown) to purify and otherwise condition air 16 or other working fluid entering the gas turbine 12. The air 16 flows to a compressor section where a compressor 18 progressively imparts kinetic energy to the air 16 to produce compressed air as indicated schematically by arrows 20.

The compressed air 20 is mixed with a fuel 22 such as natural gas from a fuel supply system 24 to form a combustible mixture within one or more combustors 26. The combustible mixture is burned to produce combustion gases as indicated schematically by arrows 28 having a high temperature, pressure and velocity. The combustion gases 28 flow through a turbine 30 of a turbine section to produce work. For example, the turbine 30 may be connected to a shaft 32 so that rotation of the turbine 30 drives the compressor 18 to produce the compressed air 20. Alternately or in addition, the shaft 32 may connect the turbine 30 to a generator 34 for producing electricity.

Exhaust gases 36 from the turbine 30 flow through an exhaust section 38 that connects the turbine 30 to an exhaust stack 40 downstream from the turbine 30. The exhaust section 38 may include, for example, a heat recovery steam generator (HRSG) 42 for cleaning and extracting additional heat from the exhaust gases 36 prior to release to the environment. For example, the HRSG 42 may include one or more heat exchangers 44 in thermal communication with the exhaust gases 36 and which may generate steam or superheated steam as indicated schematically by arrows 46. The steam 46 may then be routed to various components at the power plant 10 such as to one or more steam turbines 48 and/or to various heating systems (not shown).

In various embodiments, the gas turbine 12 may include one or more bleed air extraction ports 50. In particular embodiments, as illustrated in FIG. 1, at least one bleed air extraction port 50 provides a flow path out of the compressor 18 upstream from a compressor discharge or diffuser casing 52. In particular embodiments, as illustrated in FIG. 1, at least one bleed air extraction port 50 provides a flow path out of the compressor discharge casing 52. In particular embodiments, the bleed air extraction port(s) 50 may be used to reduce pressure within the combustor 26 such as during a non-premix mode of operation. In various embodiments, the gas turbine 12 may include at least one bleed air inlet port 54.

The bleed air extraction ports 50 may be in fluid communication with various external components. For example, in one embodiment, at least one bleed air extraction port 50 may be in fluid communication with the inlet system 14 via various fluid conduits, couplings, valves and/or at least one bleed air inlet port 54. In this manner, a portion of the compressed air 20 from the compressor 18 and/or the compressor discharge casing 52 may be directed to the inlet system 14 to provide heat to air 16 upstream from the compressor 18 and/or to reduce pressure within the combustor 26 and/or the compressor discharge casing 52.

In particular embodiments, at least one extraction port 50 may be in fluid communication with the turbine 30 via various fluid conduits, couplings, valves and/or at least one bleed air inlet port 54. In this manner, a portion of the compressed air 20 from the compressor 18 and/or the compressor discharge casing 52 may be routed to the turbine 30 to provide cooling to various components of the turbine 30 and/or to reduce pressure within the combustor 26 and/or the compressor discharge casing 52. In particular embodiments, at least one extraction port 50 may be in fluid communication with the turbine 30 via various fluid conduits, couplings, valves and/or at least one bleed air inlet port 54. In this manner, a portion of the compressed air 20 from the compressor 18 and/or the compressor discharge casing 52 may be routed to the turbine 30 to provide cooling to various components of the turbine 30 and/or to reduce pressure within the combustor 26 and/or the compressor discharge casing 52.

In particular embodiments, at least one extraction port 50 may be in fluid communication with the exhaust section 38 via various fluid conduits, couplings, valves and/or at least one bleed air inlet port 54. In this manner, a portion of the compressed air 20 from the compressor 18 and/or the compressor discharge casing 52 may be routed to the exhaust section 38 to provide thermal energy to the HRSG 42 and/or to provide cooling to various components of the exhaust section 38 and/or to reduce pressure within the combustor 26 and/or the compressor discharge casing 52.

In particular embodiments, an oxidation catalyst module or system 56 may be positioned downstream from the turbine 30 and upstream from the exhaust stack 40. The oxidation catalyst system 56 may be used to reduce or potentially eliminate carbon monoxide (CO), unburned hydrocarbons or other undesirable emissions contained within the exhaust gases 36 flowing from the turbine 30.

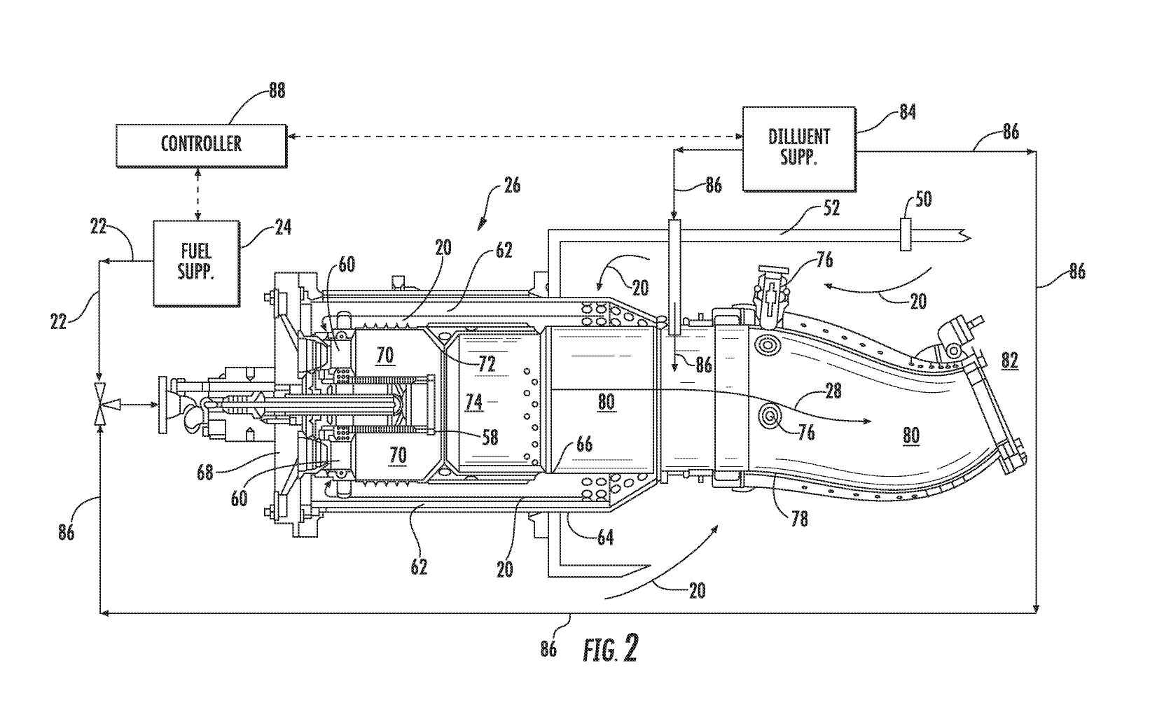

In various embodiments, the combustor 26 is a Dry Low NOx (DLN) type combustor. FIG. 2 provides a cross sectioned side view of an exemplary DLN type combustor 26 as may be incorporated into various embodiments of the present invention. In particular embodiments, as shown in FIG. 2, the combustor 26 is a DLN-1 or a DLN-1+ type combustor as manufactured by the General Electric Company, Schenectady, N.Y. A fuel injection system for the combustor 26 includes a secondary or center fuel nozzle 58 and multiple primary fuel nozzles 60 organized radially and annularly around the center fuel nozzle 58. In operation, a portion of the compressed air 20 from the compressor (FIG. 1) is channeled from the compressor discharge casing 52 through an annular flow channel 62 defined between a flow sleeve 64 and one or more combustion liners 66. The compressed air 20 reverses flow direction at an end cover or head end portion 68 of the combustor 26 and flows through and/or around the primary fuel nozzles 60 and the center fuel nozzle 58.

As shown in FIG. 2, the DLN combustor 26 includes primary combustion zones or premixing chambers 70 that are formed downstream from each primary fuel nozzle 60 and upstream from a venturi 72 which is at least partially formed by one or more of the combustion liners 66. The combustor 26 also includes a secondary or premix combustion zone 74 which is defined downstream from the primary combustion zones 70 and downstream from the center fuel nozzle 58. The primary fuel nozzles 60 and the center fuel nozzle 58 are in fluid communication with the fuel supply system 24 via various fluid conduits, flow control valves and/or couplings.

The fuel supply system 24 may be configured to provide the same fuel type such as natural gas or liquid fuel to both the primary fuel nozzles 60 and the center fuel nozzle 58. In certain configurations, the fuel supply system 24 may be configured to provide different fuel types such as natural gas and/or a liquid fuel to the primary fuel nozzles 60 and/or the center fuel nozzle 58.

During operation, the combustor 26 operates in and transitions between various modes of operation. These modes of operation are generally related to the load placed on the gas turbine and/or the steam output requirement for the power plant. The DLN type combustor 26 as shown in FIG. 2, generally operates or transitions between a primary mode of operation, a lean-lean mode of operation, a secondary mode of operation and a premix mode of operation depending on the load level required of the gas turbine 12 and/or the steam output requirements of the power plant 10. As used herein, the term “non-premix mode of operation” refers to an operating mode of the combustor 26 that is either the primary, lean-lean or the secondary operating mode up to a point of transition to the premix mode. In addition, “non-Premix mode of operation” may include any transient mode of operation which occurs between the primary, lean-lean and the secondary modes of operation.

The primary mode of operation typically occurs from ignition up to about thirty percent of full load. During primary mode of operation the fuel supply system 24 provides one hundred percent of the total fuel flow to the combustor 26 to the primary fuel nozzles 60. As a result, combustion during the primary mode of operation takes place primarily in the primary combustion zones 70. The primary mode of operation is used to ignite, accelerate and operate the gas turbine 12 over low-loads to mid-loads, up to a pre-selected combustion reference temperature.

The lean-lean mode of operation typically occurs from about thirty percent to about seventy percent of full load. During lean-lean operation the fuel supply system 24 may split the total fuel flow between the primary fuel nozzles 60 and the center fuel nozzle 58. For example, the fuel supply system 24 may provide about seventy percent of the total fuel flow to the primary fuel nozzles 60 and about thirty percent of the total fuel flow to the center fuel nozzle 58. As a result, combustion during the lean-lean mode of operation takes place in both the primary combustion zones 70 as well as the secondary combustion zone 74. This mode of operation is used for intermediate loads between two pre-selected combustion reference temperatures.

The secondary mode of operation generally occurs when the combustor 26 transitions between the lean-lean mode of operation and a premix mode of operation. During the secondary mode of operation the fuel supply system 24 may decrease the fuel flow to the primary fuel nozzles 60 from about seventy percent to about zero percent of total fuel flow to the combustor 26 while increasing the fuel flow to the center fuel nozzle 58 from about thirty percent to about one hundred percent of the total fuel flow, thus allowing the flames associated with the primary combustion zones 70 to extinguish while maintaining a flame in the secondary combustion zone 74 which originates from the center fuel nozzle 58. This mode is necessary to extinguish the flame in the primary combustion zones 70.

When the combustor 26 is in the premix mode of operation, the fuel split between the primary fuel nozzles 60 and the center fuel nozzle 58 may be modified such that the primary fuel nozzles 60 receive about eighty percent of the total fuel flow to the combustor 26 while the center fuel nozzle 58 may receive about twenty percent of the total fuel flow to the combustor 26. The fuel 22 flowing to the primary fuel nozzles 60 is premixed with the compressed air 20 from the compressor 18 (FIG. 1) within the primary combustion zones 70 which are at this point primary premix zones 70 to form a fuel lean fuel/air mixture therein. The lean premixed fuel/air mixture then flows through the venturi 72 and into the secondary combustion zone 74 where it is ignited by the flame from the center fuel nozzle 58. This mode of operation is achieved at and near the combustion reference temperature design point. Optimum emissions are generated in the premix mode.

The load ranges associated with the primary, lean-lean, secondary and premix modes of operation may shift from the ranges provided above based on various factors. For example, the load ranges may vary with a degree of inlet guide vane (IGV) modulation and, to a smaller extent, with the ambient temperature of air 16. For instance, at ISO ambient, the premix mode of operation operating range may be from about 50% to 100% load with IGV modulation down to about 42°, and about 75% to 100% load with IGV modulation down to about 57°. The various fuel splits provided herein with regards to the various modes of operation are exemplary and not meant to be limiting unless otherwise specified in the claims.

In particular embodiments, as shown in FIG. 2, the combustor 26 includes a plurality of axially staged fuel injectors 76, also known as Late Lean Injectors (LLI), annularly arranged around combustion liner 66 or a transition duct 78 (as shown) that extends downstream from the combustion liner(s) 66. The combustion liner(s) 66 and the transition duct 78 at least partially define a hot gas path 80 through the combustor 26 that extends to an inlet 82 of the turbine (FIG. 1). The fuel injectors 76 provide for fluid communication through the transition duct 78 into the hot gas path 80. The fuel injectors 76 may extend into the transition duct 78 and/or the hot gas path 80 at varying radial depths.

The fuel injectors 76 are each configured to provide Late Lean or axial fuel staging capability to the combustor 26. That is, the fuel injectors 76 are each configured to supply a fuel and/or fuel/air mixture to the hot gas path 80 in a direction that is generally transverse to a predominant flow direction of the combustion gases 28 flowing through the hot gas path 80. In so doing, conditions within the combustor 26 and the hot gas path 80 are staged to create local zones of stable combustion while reducing the formation of NOx emissions, thus enhancing overall performance of the combustor 26.

In various embodiments, as shown in FIG. 2, the combustor 26 may be fluidly coupled to a diluent supply 84. The diluent supply 84 may provide a diluent 86 such as steam, water or nitrogen to the combustor 26 upstream or downstream from the primary fuel nozzles 60 and/or the center fuel nozzle 58. For example, in particular embodiments, the diluent supply 84 may be configured to inject the diluent 86 directly into the hot gas path 80 downstream from the secondary combustion zone 74 and upstream from the plurality of fuel injectors 76. In particular embodiments, the diluent supply 84 may be configured to inject the diluent 86 into the fuel 22 upstream from the primary fuel nozzles 60 and/or the center fuel nozzle 58. The diluent 86 may be used to reduce NOx emissions levels and/or enhance combustor performance during premix and non-premix mode of operation.

As shown in FIG. 2, the fuel supply system 24 and/or the diluent source may be electronically coupled to a controller 88. The controller 88 may be programmed to direct the fuel supply system 24 to supply or split the fuel 22 flowing to the primary fuel nozzles 60 and the center fuel nozzle 58 at similar flow rates and at different flow rates based at least on part on gas turbine load and/or power plant 10 steam requirements.

The controller 88 may incorporate a General Electric SPEEDTRONIC™ Gas Turbine Control System, such as is described in Rowen, W. I., “SPEEDTRONIC™ Mark V Gas Turbine Control System”, GE-3658D, published by GE Industrial & Power Systems of Schenectady, N.Y. Controller 88 may also incorporate a computer system having a processor(s) that executes programs stored in a memory to control the operation of the gas turbine using sensor inputs and instructions from human operators. The programs executed by controller 88 may include scheduling algorithms for regulating fuel flow to the combustor 26, regulating flow of the diluent 86 to the combustor 26, steam output and for reducing combustion related emissions. The commands generated by controller 88 may, for example, cause valves to actuate between open and closed positions to regulate the flow of fuel, bleed air and diluent and may cause actuators to adjust angle of inlet guide vanes (not shown) of the inlet system 14.

The controller 88 may regulate the gas turbine 12 based, at least in part, on a database stored in the memory of the controller 88. This database may enable the controller 88 to maintain the NOx and CO emissions in the gas turbine exhaust section 38 to within certain predefined limits and to maintain the combustor 26 within suitable stability boundaries. The controller 88 may set operational parameters such as the gas turbine load, steam production requirements, inlet bleed heat, flow of diluent and combustor fuel split so as to: 1) achieve the desired steam production output rate while operating in a non-premix mode and/or operating between a full speed no load (FSNL) condition up to a base load condition; while 2) staying within desired emissions boundaries.

During base load or peak load, the combustor 26 is operated in the premix mode. While in this operating mode, emissions levels are generally maintained within desired acceptable emissions levels and operation of the HRSG 42 is optimized to provide sufficient steam flow to drive the steam turbine 48 and/or support various secondary operations. During non-peak or base load demand, operators may wish to maintain a minimum steam output independent of the gas turbine load level. However, during turndown operation of the gas turbine 12 emissions levels increase. Therefore, in order to meet steam output requirements while maintaining overall emissions compliance for the power plant 10, operators typically operate the gas turbine 12 at base load operation or have to accept the increase in overall emissions output.

In order to reduce emission levels and decouple steam output from the gas turbine load during non-premix mode of operation and/or during turndown operation, bleed air (compressed air 20) may be extracted from one or more of the bleed air extraction ports 50 to achieve maximum turndown. The bleed air may be routed to at least one of the inlet system 14, the turbine 30 or the exhaust section 38. The bleed air reduces the pressure within the combustor 26 and/or the compressor discharge casing 52, thus preventing blow-out of the combustion flames. In addition, the bleed air may be used to heat the inlet air 16 upstream from the compressor 18 and/or may be used to add thermal energy to the exhaust gases 36 upstream from the HRSG 42.

The diluent 86 (i.e. steam, water, nitrogen, etc. . . . ) may be injected into the fuel 22 upstream form the primary fuel nozzles 60 and the center fuel nozzle 58 and/or may be injected into the combustion gases 28 within the hot gas path 80 via the diluent supply 84 to reduce NOx production within the hot gas path 80. In addition, the fuel injectors 76 may inject the fuel or fuel/air mixture into the hot gas path downstream from the secondary combustion zone 74, thus reducing NOx within the combustion gases 28. The oxidation catalyst system 56 may be activated to further reduce various undesirable emissions such as carbon monoxide (CO) from the exhaust gases 36 at the less than base load condition as they flow through the exhaust section 36 towards the exhaust stack 40. In this configuration, desired levels of steam output from the power plant 10 may be maintained while mitigating the emissions levels at less than base load or non-premix operating conditions.

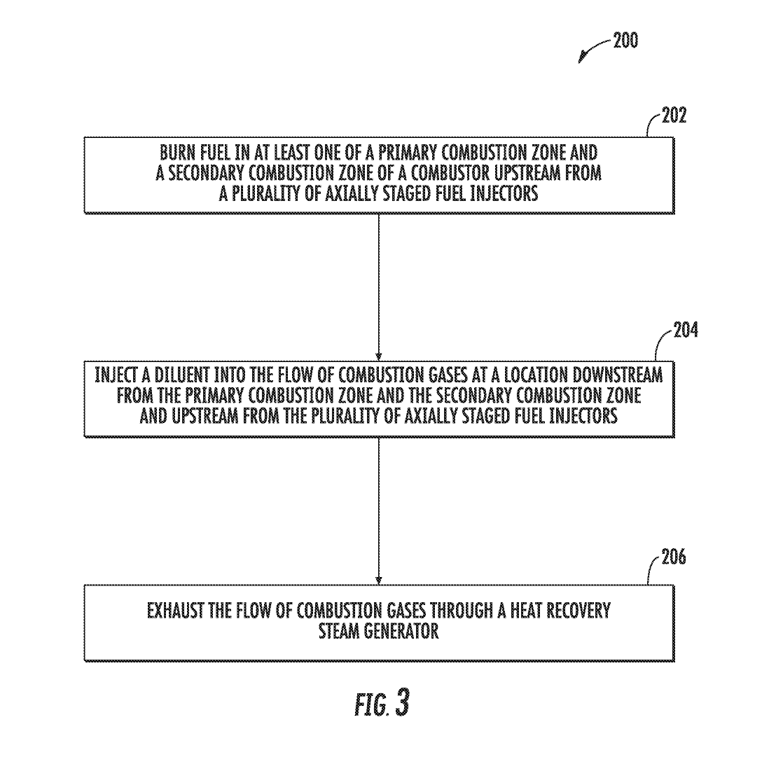

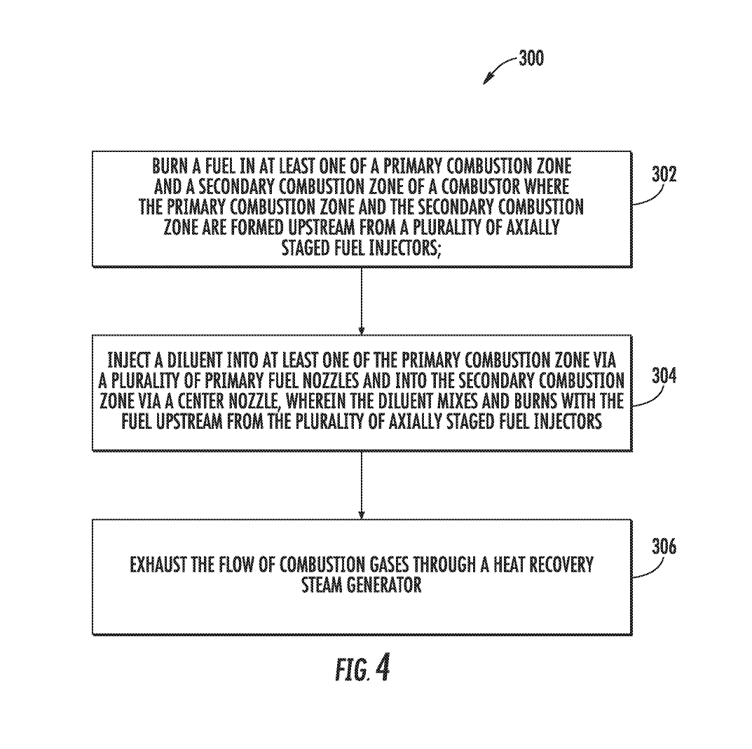

The various embodiments and figures provided herein provide a first method for decoupling steam production dependency from gas turbine load. FIG. 3 provides a block diagram of a first method 200 for decoupling steam production dependency from gas turbine load. FIG. 4 provides a block diagram of a second method 300 for decoupling steam production dependency from gas turbine load. As shown in FIG. 3, at step 202, method 200 includes burning fuel 22 to generate a flow of combustions gases 28 through the hot gas path 80 of the combustor 26 where the fuel 22 is burned in at least one of a primary combustion zone 70 and/or the secondary combustion zone 74 of the combustor 26 and where the primary combustion zone 70 and the secondary combustion zone 74 are formed upstream from the plurality of axially staged fuel injectors 76. At step 204, method 200 further includes injecting a diluent 86 into the flow of combustion gases 28 within the hot gas path 80. The diluent 86 may be injected into the flow of combustion gases 28 at a location that is defined downstream from the primary combustion zone 70 and the secondary combustion zone 74 and upstream from the plurality of axially staged fuel injectors 76. At 206, method 200 may also include exhausting the flow of combustion gases 28 through the heat recovery steam generator 42.

In particular embodiments, method 200 may include injecting a diluent 86 into the hot gas path 80 downstream from the primary combustion zone 70 and the secondary combustion zone 74 and upstream from the plurality of axially staged fuel injectors 76 where the diluent 86 includes at least one of steam, water and nitrogen. In particular embodiments, method 200 may include scrubbing the combustion gases 28 via the oxidation catalyst system 56 disposed within the exhaust stack 38 upstream from the heat recovery steam generator 42. In particular embodiments, method 200 may include extracting compressed air 20 from the compressor 18 and routing the compressed air 20 into the inlet section 14. In particular embodiments, method 200 may include extracting compressed air 20 from at least one of the compressor 16 and the combustor 26, and routing the compressed air 20 to at least one of the inlet section 14, the turbine 30 and the exhaust stack 38 upstream from the heat recovery steam generator 42.

As shown in FIG. 4, at step 302, method 300 includes burning fuel 22 to generate the flow of combustions gases 28 through the hot gas path 80 of the combustor 16 where the fuel 20 is burned in at least one of the primary combustion zone 70 and the secondary combustion zone 74 of the combustor 16 and where the primary combustion zone 70 and the secondary combustion zone 74 are formed upstream from the plurality of axially staged fuel injectors 76. At step 304, method 300 includes injecting diluent 86 into at least one of the primary combustion zone 70 via the plurality of primary fuel nozzles 60 and into the secondary combustion zone 74 via center nozzle 58 where the diluent mixes 86 and burns with the fuel 22 upstream from the plurality of axially staged fuel injectors 76. The method further includes exhausting the flow of combustion gases 28 through the heat recovery steam generator 44 disposed within the exhaust stack 38.

Although specific embodiments have been illustrated and described herein, it should be appreciated that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed:

1. A system for decoupling steam production dependency from gas turbine load, comprising:
a gas turbine having an inlet system, a compressor, a combustor and a turbine, the combustor comprising a plurality of axially staged fuel injectors positioned downstream from a plurality of primary fuel nozzles and a center fuel nozzle, the gas turbine further comprising at least one bleed air extraction port, wherein the bleed air extraction port is in fluid communication with at least one of the compressor, a compressor discharge casing or the combustor;
a diluent injection system in fluid communication with the combustor; and
an exhaust section disposed downstream from the turbine, the exhaust section comprising an oxidation catalyst system and a heat recovery steam generator, wherein the oxidation catalyst system and the heat recovery steam generator receive an exhaust gas from an outlet of the turbine.

2. The system as in claim 1, wherein the at least one bleed air extraction port is fluidly coupled to the compressor and to an inlet section of the gas turbine via a bleed air inlet port.

3. The system as in claim 1, wherein the at least one bleed air extraction port is fluidly coupled to the compressor and to the turbine via a bleed air inlet port.

4. The system as in claim 1, wherein the at least one bleed air extraction port is fluidly coupled to the compressor and to the exhaust section of the gas turbine upstream from the heat recovery steam generator via a bleed air inlet port.

5. The system as in claim 1, wherein the at least one bleed air extraction port is fluidly coupled to the combustor and to an inlet section of the gas turbine via a bleed air inlet port.

6. The system as in claim 1, wherein the at least one bleed air extraction port is fluidly coupled to the combustor and to the turbine via a bleed air inlet port.

7. The system as in claim 1, wherein the at least one bleed air extraction port is fluidly coupled to the combustor and to the exhaust section of the gas turbine upstream from the heat recovery steam generator via a bleed air inlet port.

8. The system as in claim 1, wherein the oxidation catalyst system is disposed downstream from the turbine and upstream from the heat recovery steam generator.

9. The system as in claim 1, wherein the diluent injection system includes a diluent supply in fluid communication with the primary fuel nozzles, wherein the diluent supply provides a diluent comprising at least one of steam, water and nitrogen.

10. The system as in claim 1, wherein the diluent injection system includes a diluent supply in fluid communication with a hot gas path of the combustor at a location upstream from the plurality of axially staged fuel injectors and downstream from the center fuel nozzle, wherein the diluent supply provides a diluent comprising at least one of steam, water and nitrogen to the hot gas path.

11. A method for decoupling steam production dependency from gas turbine load, comprising:
burning a fuel to generate a flow of combustions gases through a hot gas path of a combustor, wherein the fuel is burned in at least one of a primary combustion zone and a secondary combustion zone of the combustor, wherein the primary combustion zone and the secondary combustion zone are formed upstream from a plurality of axially staged fuel injectors;
injecting a diluent into the flow of combustion gases within the hot gas path, wherein the diluent is injected into the flow of combustion gases at a location downstream from the primary combustion zone and the secondary combustion zone and upstream from the plurality of axially staged fuel injectors; and
exhausting the flow of combustion gases through a heat recovery steam generator.

12. The method as in claim 11, wherein injecting a diluent into the hot gas path downstream from the primary combustion zone and the secondary combustion zone and upstream from the plurality of axially staged fuel injectors includes injecting at least one of steam, water and nitrogen into the hot gas path.

13. The method as in claim 11, further comprising scrubbing the combustion gases via an oxidation catalyst system disposed within the exhaust stack upstream from the heat recovery steam generator.

14. The method as in claim 11, further comprising extracting compressed air from a compressor disposed upstream from the combustor and routing the compressed air to an inlet section disposed upstream from the compressor.

15. The method as in claim 11, further comprising extracting compressed air from at least one of a compressor disposed upstream from the combustor and the combustor, and routing the compressed air to at least one of an inlet section disposed upstream from the compressor, a turbine disposed downstream from the combustor and the exhaust stack upstream from the heat recovery steam generator.

16. A method for decoupling steam production dependency from gas turbine load, comprising:
burning a fuel to generate a flow of combustion gases through a hot gas path of a combustor, wherein the fuel is burned in at least one of a primary combustion zone and a secondary combustion zone of the combustor, wherein the primary combustion zone and the secondary combustion zone are formed upstream from a plurality of axially staged fuel injectors;
injecting a diluent into at least one of the primary combustion zone via a plurality of primary fuel nozzles and into the secondary combustion zone via a center nozzle, wherein the diluent mixes and burns with the fuel upstream from the plurality of axially staged fuel injectors; and
exhausting the flow of combustion gases through a heat recovery steam generator disposed within an exhaust stack.

17. The method as in claim 16, wherein injecting a diluent into at least one of the primary combustion zone via the plurality of primary fuel nozzles and into the secondary combustion zone via the center nozzle includes injecting at least one of steam, water and nitrogen into the hot gas path.

18. The method as in claim 16, further comprising scrubbing the flow of combustion gases via an oxidation catalyst system disposed within the exhaust stack upstream from the heat recovery steam generator.

19. The method as in claim 16, further comprising extracting compressed air from a compressor disposed upstream from the combustor and routing the compressed air to an inlet section disposed upstream from the compressor.

20. The method as in claim 16, further comprising extracting compressed air from the combustor and routing the compressed air to at least one of an inlet section disposed upstream from the compressor, a turbine disposed downstream from the combustor and the exhaust stack upstream from the heat recovery steam generator.
